(19) United States
(12) Patent Application Publication
(10) Pub. No.: US 2016/0070880 A1
(43) Pub. Date: Mar. 10, 2016

(54) METHOD AND SYSTEM FOR PREDICTING CONTINOUS CARDIAC OUTPUT (CCO) OF A PATIENT BASED ON PHYSIOLOGICAL DATA

(71) Applicant: PRAVEEN KODURU, The Woodlands, TX (US)

(72) Inventor: PRAVEEN KODURU, The Woodlands, TX (US)

(73) Assignee: iQG LLC DBA iQGATEWAY, THE WOODLANDS, TX (US)

(21) Appl. No.: 14/877,756

(22) Filed: Oct. 7, 2015

Related U.S. Application Data
(60) Provisional application No. 62/061,970, filed on Oct. 9, 2014.

(51) Int. Cl. G06F 19/00

(52) U.S. Cl. CPC G06F 19/3437; G06F 19/36; G06F 19/32; G06F 19/345; G06F 19/3443

(57) ABSTRACT

The various embodiments of the present invention disclose a method and system for predicting a physiological condition of a patient during post-surgery recovery in Intensive Care Unit (ICU). The physiological condition is the Continuous Cardiac Output (CCO) of a patient ahead of time based on past physiological data. The method comprises of developing a clinical database containing a clinical data captured from a plurality of historical patients having similar patient profiles, the clinical data comprising physiological data, vital signs, demographic details, pretreatment symptoms, and treatments, of historical patients, identifying recovery patterns for the similar patient profiles which exhibits likewise response to a selected treatment regime, utilizing the recovery patterns for learning the behavioral response of a physiological parameter of a patient and creating a prediction model to enable automated classification of similar patient profiles from existing recovery patterns of known symptoms and known responses to at least one treatment regime.

### CROSS REFERENCE TO RELATED APPLICATIONS

This application claims the benefit of U.S. Provisional Patent Application 62/061,970, titled “METHOD AND SYSTEM FOR PREDICTING CONTINIOUS CARDIAC OUTPUT (CCO) OF A PATIENT BASED ON PHYSIOLOGICAL DATA” and filed on Oct. 9, 2014 the entire disclosure of which is hereby incorporated by reference herein for all purposes.

### FIELD OF TECHNOLOGY

This present disclosure generally relates to patient monitoring systems and methods, and particularly relates to a method and system for continuously monitoring cardiac parameters of a patient for predicting the Continuous Cardiac Output (CCO).

### BACKGROUND

Prognosis of patients during recovery relies on monitoring and analysing various physiological data that is collected over time to analyse and identify potential problems ahead of time. Especially in intensive care units such data becomes invaluable and hence patients are continuously monitored on various vital signs for providing proactive care.

Patients are continuously monitored on various physiological data and vital signs during their post-surgery recovery in ICU. Cardiac output, the volumetric rate at which blood is pumped through the heart, is one of the most important cardiovascular parameters. The cardiac output reflects the supply of oxygen and nutrients to the tissue of the patient. Measurements of cardiac output provide invaluable clinical information for quantifying the extent of cardiac dysfunction, indicating the optimal course of therapy, managing patient progress, and establishing check points for rehabilitation in a patient with a damaged or diseased heart, or one in whom fluid status control is essential. Exercise, as well as pathological conditions of the heart and circulatory system will alter cardiac output; therefore, the measurement of cardiac output is useful both in rehabilitation and critically ill patients.

A previously known continuous, non-invasive method for measuring cardiac output is based on the measurement of body impedance. In impedance-cardiographic measurement, electrodes are placed on the upper part of the patient's body, and the impedance between the electrodes is measured. The electrical impedance thus measured shows cyclic changes due to cardiac activity, allowing cardiac output to be calculated on the basis of theoretic models and empiric formulas. Impedance measurement has the advantage of simplicity, and that it allows continuous, fast and non-invasive measurement of cardiac output. However, a significant drawback with the method is its inaccuracy and inability to forecast into future, because these models are simple empirical formulas based on correlation factors and assumptions that are not sufficient for accurate prediction.

In view of the foregoing, there is a need to provide a method and system for predicting the Continuous Cardiac Output (CCO) of a patient ahead of time.

The above mentioned shortcomings, disadvantages and problems are addressed herein and which will be understood by reading and studying the following specification.

### SUMMARY

The primary objective of the embodiments herein is to provide a method and system for creating a model to predict the Continuous Cardiac Output (CCO) of a patient in near future based on other physiological data.

Another objective of the embodiments herein is to provide a model to accurately assess the condition of the patient ahead of time.

The embodiments herein disclose a method for predicting a physiological condition of a patient ahead of time using other related clinical data during post-surgery recovery in Intensive Care Unit (ICU). The method comprises of developing a clinical database containing a clinical data captured from a plurality of historical patients having similar patient profiles, identifying one or more recovery patterns for the similar patient profiles which exhibits likewise response to a selected treatment regime utilizing the one or more recovery patterns for learning the behavioral response of a physiological parameter of a patient and creating a prediction model to enable automated classification of one or more similar patient profiles from existing recovery patterns of known symptoms and known responses to at least one treatment regime. The clinical data herein comprises physiological data, vital signs, demographic details, pretreatment symptoms, treatments, and responses thereto, of the plurality of historical patients.

According to an embodiment herein, the method further comprises providing the current physiological data of the patient as an input to the prediction model and predicting the physiological parameter of the patient ahead of time. The physiological parameter herein comprises of a Continuous Cardiac Output (CCO) of the patient and the demographic data comprises of the age, race and sex of the patient.

According to an embodiment herein, the physiological data comprises of Arterial Pressures (Systolic, Diastolic and Mean) (AR), Heart Rate (HR), Central Venous Pressure (CVP/RA), Pulmonary Artery Pressure (PA/PAP), Peripheral capillary oxygen saturation (SpO2), Mixed venous oxygen saturation (SvO2), Core body temperature (CBT) and Continuous Systemic Vascular Resistance (CSVR).

According to an embodiment herein, the method further comprises of preforming pre-processing of the captured clinical data of the patient, where the captured data is imputed with interpolation to obtain missing data streams in the captured data.

According to an embodiment herein, the prediction model is adapted to learn patterns from the input data streams and identify patterns which show similar patterns across different patients.

According to an embodiment herein, the accuracy of the prediction of the physiological parameter of the patient is determined based on regression trees, which generates a collection of rules with regression models to generate predictions accurately. Here the method of determining the accuracy of prediction of the physiological parameter comprises of splitting the captured clinical data into one or more training data sets and testing data sets, creating a rule based model using the one or more training data sets, estimating the predicted physiological parameter values from the one or more testing data sets and determining the accuracy of the predicted parameter values by comparing an output of the rule based model with the actual captured data.

According to an embodiment herein, one of a squared error or correlation metric is implemented to validate the accuracy of predicted physiological parameter values.

Embodiments herein further disclose a system for predicting a physiological condition of a patient, the system comprising a Continuous Data Capturing unit, a Data Processing Unit, a Predictive Model Generator and a display unit. The Continuous Data Capturing Unit is configured for monitoring a plurality of patients during post-surgery recovery; and developing a clinical database containing a clinical data captured from a plurality of historical patients having similar patient profiles. The clinical data comprising physiological data, vital signs, demographic details, pretreatment symptoms, treatments, and responses thereto, of the plurality of historical patients. The data processing unit configured for identifying one or more recovery patterns for the similar patient profiles which exhibits likewise response to a selected treatment regime, utilizing the one or more recovery patterns for learning the behavioral response of a physiological parameter of a patient and a Predictive Model Generator configured for creating a prediction model to enable automated classification of one or more similar patient profiles from existing recovery patterns of known symptoms and known responses to at least one treatment regime and predicting the physiological parameter of the patient ahead of time based on the captured physiological data of the patient.

According to an embodiment herein, the data processing unit is further adapted for processing the captured clinical data of the patient, where the captured data is imputed with linear interpolation to obtain missing data streams in the captured data and for determining the accuracy of the predicted parameter values by comparing an output of the prediction model with the actual captured data.

According to an embodiment herein, the display device is adapted to receive the calculated CCO level from the data processing unit and displays the CCO level of the patient ahead of time.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a flow chart illustrating a method of predicting Continuous Cardiac Output (CCO) of a patient ahead of time, according to an embodiment herein.

FIG. 2 is a block diagram illustrating a system for predicting Continuous Cardiac Output (CCO) of a patient ahead of time, according to an embodiment herein.

FIG. 3 is a graphical representation illustrating a sample time series for comparing the nearest neighbor interpolation and the linear interpolation to represent the missing data replacement, according to an embodiment herein.

FIG. 4 is a plot diagram illustrating a trained model prediction of CCO 10 minutes into future based on input training data, according to an exemplary embodiment herein.

FIG. 5 is a plot diagram illustrating a prediction of CCO 10 minutes into future with the testing data to validate the prediction model, according to an exemplary embodiment herein.

FIG. 6 is a plot diagram illustrating a trained model prediction of CCO 30 minutes into future based on input training data, according to another exemplary embodiment herein.

FIG. 7 is a plot diagram illustrating the prediction of CCO 30 minutes into future by the prediction model with the testing data to validate the model, according to another exemplary embodiment herein.

FIG. 8 is a plot diagram illustrating a trained model prediction of CCO 60 minutes into future based on input training data, according to an exemplary embodiment herein.

FIG. 9 is a plot diagram illustrating the prediction of CCO 60 Minutes into future by the prediction model with the testing data to validate the model, according to an exemplary embodiment herein.

Although specific features of the present invention are shown in some drawings and not in others. This is done for convenience only as each feature may be combined with any or all of the other features in accordance with the present invention.

### DETAILED DESCRIPTION OF THE EMBODIMENTS

The present invention provides a method and system for predicting future values of continuous cardiac output of a patient under observation in ICU from a plurality of physiological parameters using a prediction model. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The patients are continuously monitored on various physiological data and vital signs during their post-surgery recovery in intensive care units (ICU). The inherent patterns are generated based on historical data collected from patients in the past, where such data corresponds to similar patients' profiles that exhibit similar behavior or response to the medical care provided. These patterns are then utilized to generate models of predictive nature which can provide new incoming patients their prognosis into the future. The modeling approach as disclosed herein leads to identification of potentially useful patterns of recovery and further the generated models leads to prediction of a patient's condition during recovery.

According to an embodiment herein, the physiological data collected from patients in the ICU who have undergone cardiac surgery is analyzed. The patients are monitored continuously and various physiological data is collected on a minute by minute basis during their recovery to normality under medical supervision in the ICU.

According to an embodiment of the present invention, the continuously monitored data that is collected from past patients (who have undergone cardiac surgery) is used to generate patterns. These patterns are then utilized to learn the possible future continuous cardiac output (CCO) responses of patients with similar patient profile. Further a prediction model is created, which learns the generated inherent patterns to enable automated classification of similar CCO response profiles and enable prediction of CCO ahead of time for new incoming patients whose current physiological data is provided as an input to the model.

The time series data which is collected from multiple patients during the patients stay in the ICU is provided as an input for training and testing the model generated. The following data variables are collected from the patients for predicting the CCO.
Arterial Pressures (Systolic, Diastolic and Mean) (AR)
Heart Rate (HR)
Central Venous Pressure (CVP/RA)
Pulmonary Artery Pressure (PA/PAP)
Peripheral capillary oxygen saturation (SpO2)
Mixed venous oxygen saturation (SvO2)
Core body temperature (CBT)
Continuous Systemic Vascular Resistance (CSVR)

The data that can be used for modeling may not be limited to these variables and additional physiological data can also be utilized for further enhancing the prediction accuracy of the model.

According to an embodiment herein, the prediction model herein performs data preprocessing, to compensate for the missing data in the physiological data readings captured by the ICU data capturing systems due to various operational and sensor issues. The missing data can be either filtered out from analysis or if only a small section of data is missing, then the data is imputed using various interpolation techniques. According to the embodiments herein, the data is imputed with linear interpolation. However, if a large section of data is missing, then linear interpolation on vital parameters is insufficient to provide accurate missing information.

In view of the foregoing, the data is collected for modeling from only those patients who meet the following criteria:
Patients with at least 80% of Central Venous Pressure (CVP) or Right Atrial Pressure (RAP) populated for their stay in ICU
Patients with at least 80% of Aortic Regurgitation (AR) populated for their stay in ICU
Patients with at least 80% of Continuous Cardiac Output (CCO) or Cardiac Output (CO) populated for their stay in ICU

The data collected from all the patients who meets the above conditions is considered sufficient to be utilized for generating the prediction models. Any missing data from a variable, which could account for a maximum of 20% of time series, can be imputed using linear interpolation.

The predictive model disclosed herein is adapted to predict or forecast values for continuous stream of data given a past historical trend. The main objective of the model is to learn the patterns from the input training data streams and identify patterns that potentially show similar trends across different patients. These trends are not easily identified with simple statistical analysis and there is a need for more complicated models that can learn the intricate patterns embedded in the time series data. The modeling approach employed herein is based on regression trees which generates a collection of rules with regression models to generate predictions accurately. A tree based rule model learner is also used to generate rules that provide the predictions for CCO.

In the embodiments disclosed herein, around 60% of complete data set is only utilized for learning the model, the rest of 40% of data is used for testing.

The patients are continuously monitored on various physiological data and vital signs during their post-surgery recovery in intensive care units (ICU). The patients are monitored continuously and various physiological data is collected on a minute by minute basis during their recovery to normality under medical supervision in the ICU. The inherent patterns are generated based on historical data collected from patients in the past, where such data corresponds to similar patients' profiles that exhibit similar behavior or response to the medical care provided. These patterns can be utilized to generate models of predictive nature which can provide new incoming patients their prognosis into the future. The modeling approach as disclosed herein leads to identification of potentially useful patterns of recovery and further the generated models leads to prediction of a patient's condition during recovery.

According to an embodiment of the present invention, the continuously monitored data that is collected from past patients (cardiac surgery) is used to generate patterns. These patterns are then utilized to learn the possible future continuous cardiac output (CCO) responses of such patients. Further a model is built, which learns the generated inherent patterns to enable automated classification of similar CCO response profiles and enable prediction of CCO ahead of time for new incoming patients whose current physiological data is provided as an input to the model.

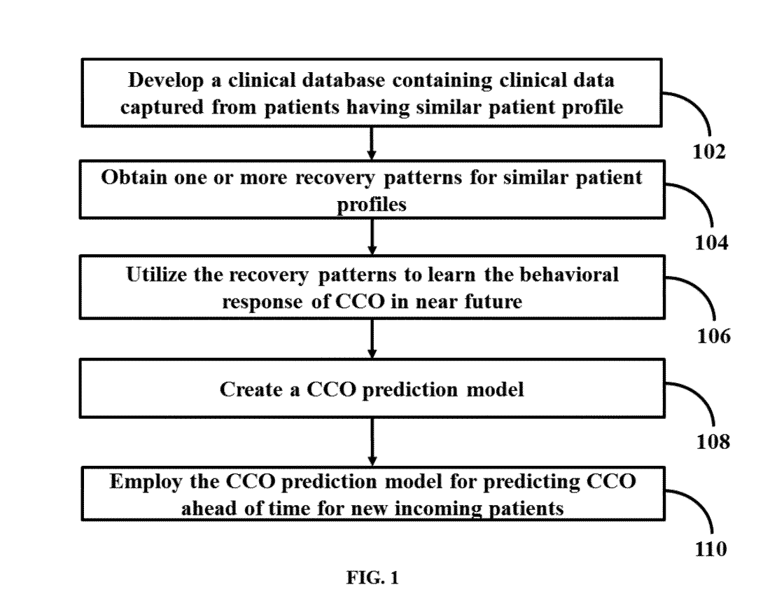

FIG. 1 is a flow chart illustrating a method of predicting Continuous Cardiac Output (CCO) of a patient ahead of time, according to an embodiment herein. At step 102, develop a clinical database containing a clinical data captured from a plurality of historical patients having similar patient profiles. The clinical data herein comprises physiological data, vital signs, demographic details, pretreatment symptoms, treatments, and responses thereto, of the plurality of historical patients. At step 104, check for existing recovery patterns of similar patient profiles that exhibit likewise behavior or response to the medical care provided. At step 106, utilize these patterns for learning the behavioral response of CCO in near future. At step 108, build a prediction model adapted to learn the inherent patterns within the data to enable automated classification of similar response profiles and enable prediction of CCO in near future. At step 110, apply the prediction model to predict the CCO ahead of time for new incoming patients whose current physiological data is provided as an input to the prediction model.

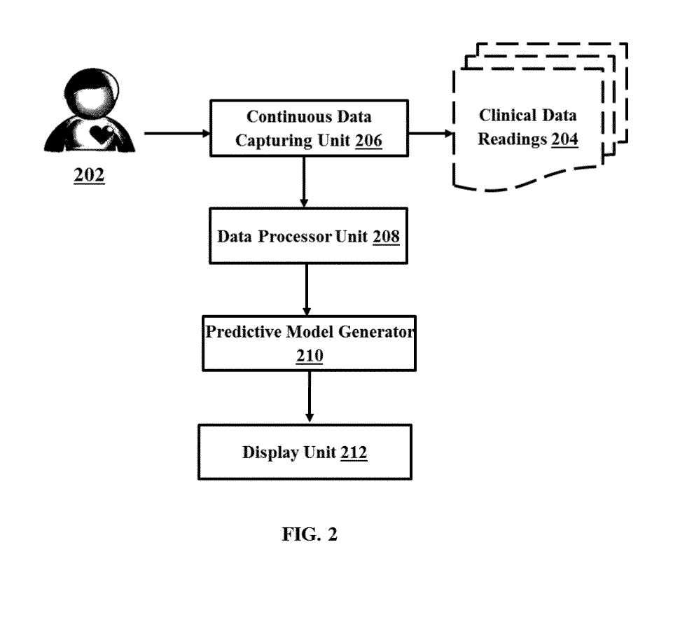

FIG. 2 is a block diagram illustrating a system for predicting Continuous Cardiac Output (CCO) of a patient ahead of time, according to an embodiment herein. The system comprises a Continuous Data Capturing Unit 206, a Data Processor unit 208, a Predictive Model Generator 210 and a Display unit 212. The continuous data capturing unit 204 continuously monitors the patients 202 for recording various clinical data 206 and vital signs during their post-surgery recovery in ICU. The continuous data capturing unit 204 further develops a clinical database containing a clinical data captured from the plurality of historical patients having similar patient profiles. The clinical data comprising physiological data, vital signs, demographic details, pretreatment symptoms, treatments, and responses thereto, of the plurality of historical patients.

The data processor unit 208 processes the input data and identifies one or more recovery patterns for the similar patient profiles which exhibits likewise response to a selected treatment regime and employ the one or more recovery patterns for learning the behavioral response of a physiological parameter of a patient. According to an embodiment of the present invention, the physiological parameter being monitored herein is the Continues Cardiac Output (CCO) of the patient.

Further the Predictive Model Generator 210 utilizes the information across the different data variables collected for building a prediction model to enable automated classification of one or more similar patient profiles from existing recovery patterns of known symptoms and known responses to at least one treatment regime and predicting the Continuous Cardiac Output (CCO) of the patient ahead of time based on the captured physiological data of the patient.

The display unit is adapted to display the predicted physiological parameter of the patient received from the data processing unit ahead of time.

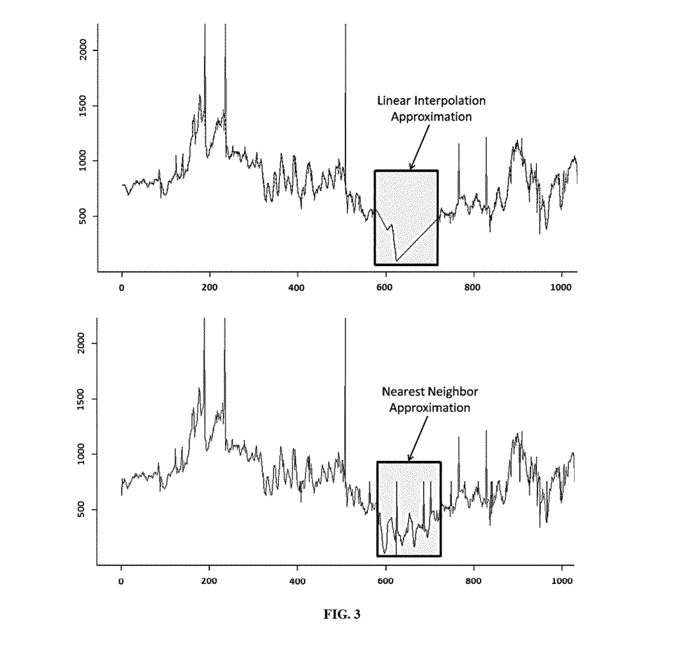

FIG. 3 is a graphical representation of a sample time series for comparing the nearest neighbor interpolation vs. linear interpolation to represent the missing data replacement according to an embodiment herein. As shown in FIG. 3, the data imputation using a nearest calculated clinical data value is performed to fill in the missing data streams for short sections of missing data. The interpolation for nearest neighbor is done by comparing all the physiological variables data among all the patients that was collected for creating the prediction model.

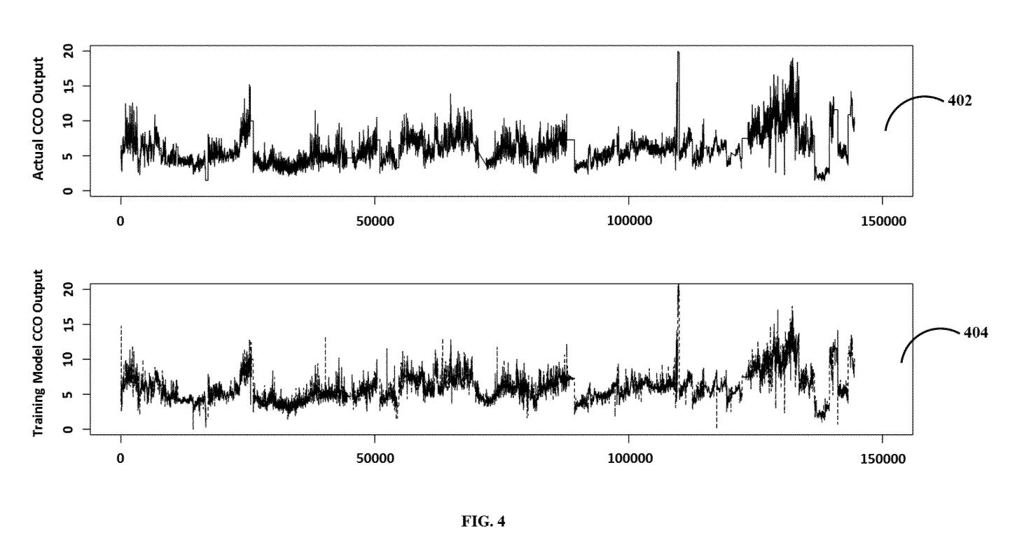

FIG. 4 is a plot diagram illustrating a trained model prediction of CCO based on input training data, according to an exemplary embodiment herein. The prediction model is trained on input data to learn the forecasted output of CCO 10 Minutes into the future. The first plot 402 represents the actual value of CCO to be predicted and the second plot 404 represents the output of the trained model prediction of CCO. The plot clearly illustrates that the prediction model is able to accurately learn the recovery patterns for predicting CCO from the training data.

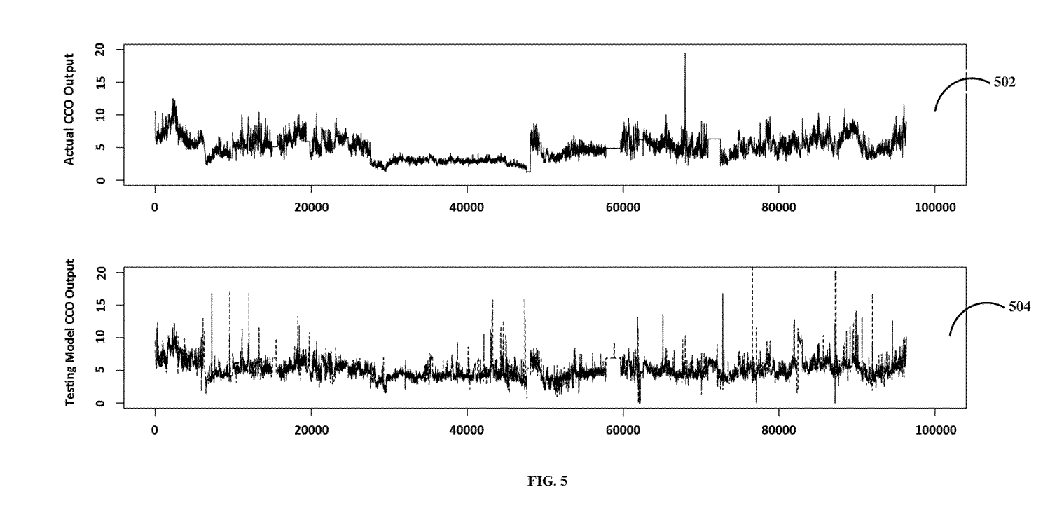

FIG. 5 is a plot diagram illustrating the prediction of CCO 10 minutes into the future with the testing data to validate the prediction model, according to an exemplary embodiment herein. The first plot 502 represents the value of CCO to be predicted for 10 Minutes into future and the second plot 504 represents the actual value of CCO predicted by the prediction model. The prediction model is able to utilize the recovery patterns learned from the training data and provide accurate predictions of CCO as shown in FIG. 5.

From the above plots, it can be clearly seen that most of the times the predictions are close to the actual values of CCO. In some cases the actual predicted values are offset with a certain deviation, nonetheless it follows the trend of upward and downward movement of actual CCO values. This is vital for the physician to understand the condition of the patient, which the accurately provided by the prediction model herein.

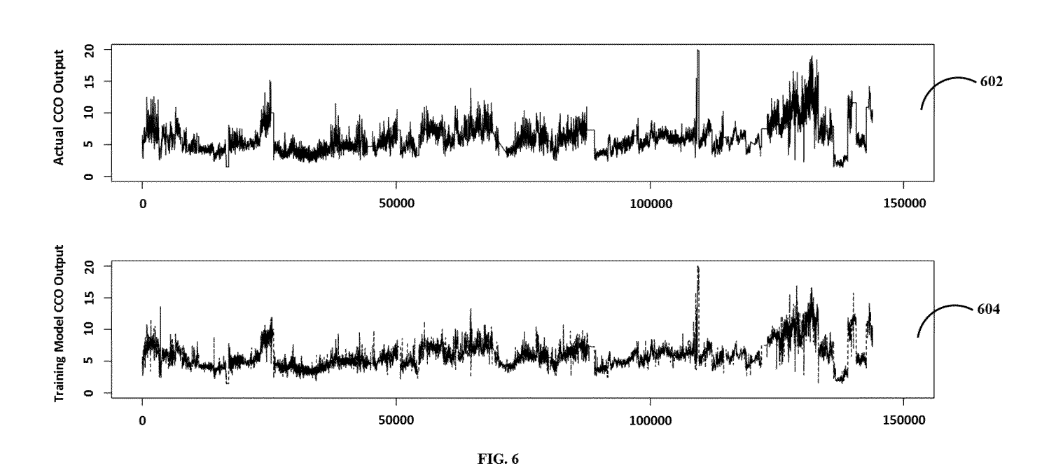

FIG. 6 is a plot diagram illustrating the trained model prediction of CCO based on the input training data, according to another exemplary embodiment herein. The prediction model is modified to predict ahead of time for 30 minutes into future the values of CCO from the current physiological readings. The plot shows the test predictions of CCO 30 minutes into future compared with original data. The first plot 602 represents the actual value of CCO (training data) to be predicted and the second plot 604 represents the trained model predictions on the training data.

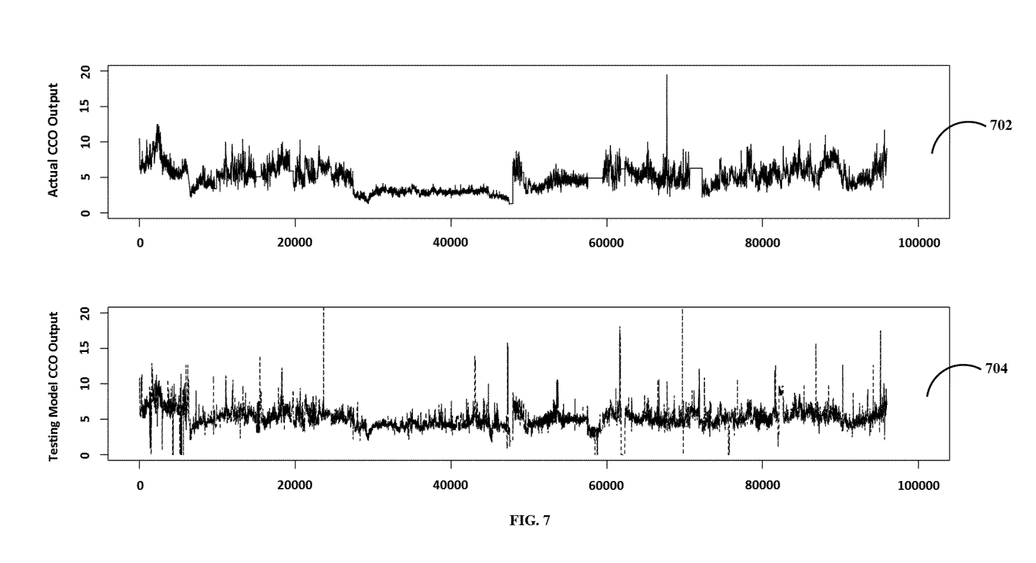

FIG. 7 is a plot diagram illustrating the prediction of CCO by the generated prediction model using the testing data to validate the model, according to another exemplary embodiment herein. The first plot 702 represents the actual value of CCO 30 Minutes into the future, which is to be predicted and the second plot 704 represents the value of CCO predicted by the prediction model. From the above plots it can be clearly seen that predicting CCO further into the future is difficult and hence there is a slight deterioration in the output accuracy of actual CCO values but the trend of CCO movement is still predicted with a high degree of accuracy.

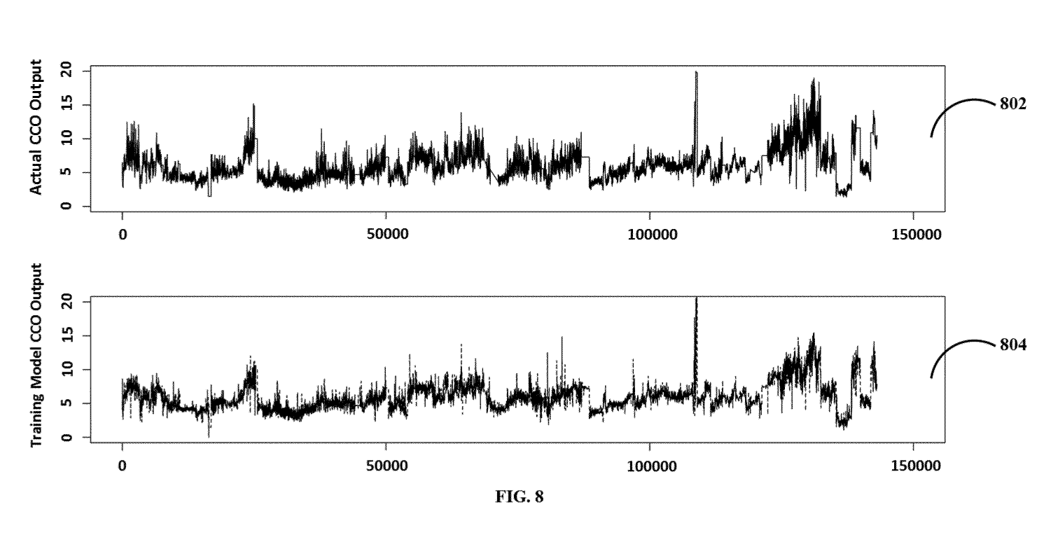

FIG. 8 is a plot diagram illustrating a trained model prediction of CCO 60 minutes into future based on input training data, according to an exemplary embodiment herein. The plot diagram illustrates that the prediction model is being trained to learn the forecasted output of CCO 60 Minutes into future and shows the trained model prediction based on the input training data. The first plot 802 represents the actual value of CCO training data to be predicted and the second plot 804 represents the trained model predictions of CCO.

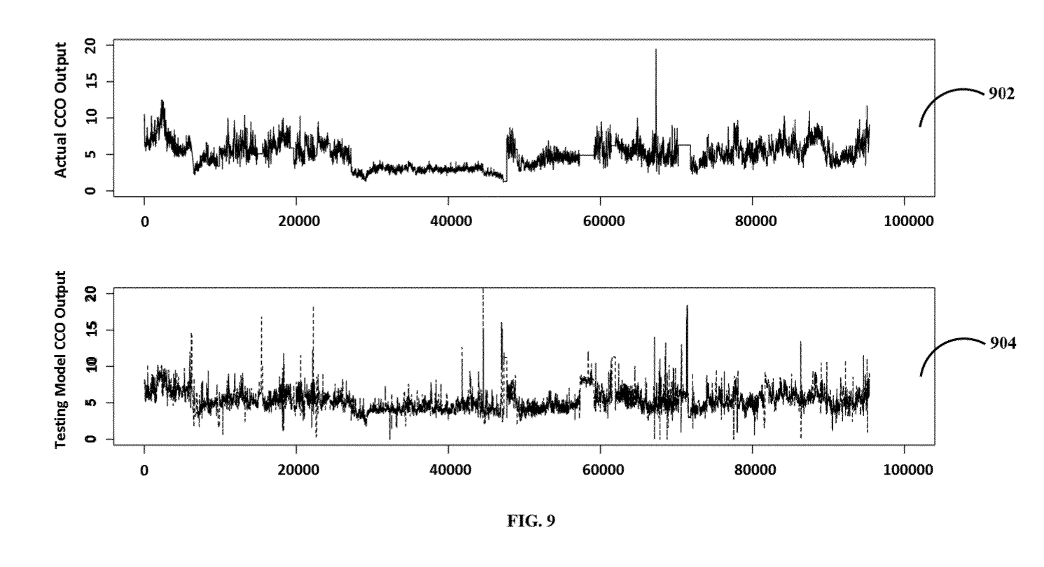

FIG. 9 is a plot diagram illustrating the prediction of CCO 60 Minutes into future by the generated model with the testing data to validate the model, according to an exemplary embodiment herein. The first plot 902 represents the value of CCO 60 Minutes into future, which is to be predicted and the second plot 904 represents the actual value of CCO predicted by the model. From the above plots it can be clearly seen that there is further deterioration in the output accuracy of actual CCO values but the trend of CCO movement is still predicted with a high degree of accuracy.

The exemplary embodiments as disclosed herein indicates that in most cases we were able to accurately estimate the CCO in the near future for 10, 30 and 60 minutes and precisely identify the trending direction of CCO which can aid in better prognosis of patients ahead of time for preventive care.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A method for predicting a physiological condition of a patient, comprising:
developing a clinical database containing a clinical data captured from a plurality of historical patients having similar patient profiles; the clinical data comprising physiological data, vital signs, demographic details, pretreatment symptoms, treatments, and responses thereto, of the plurality of historical patients;
identifying one or more recovery patterns for the similar patient profiles which exhibits likewise response to a selected treatment regime;
utilizing the one or more recovery patterns for learning the behavioral response of a physiological parameter of a patient; and
creating a prediction model to enable automated classification of one or more similar patient profiles from existing recovery patterns of known symptoms and known responses to at least one treatment regime.

2. The method of claim 1, further comprising:
providing the current physiological data of the patent as an input to the prediction model; and
predicting the physiological parameter of the patient ahead of time.

3. The method of claim 2, wherein the physiological parameter comprises of a Continuous Cardiac Output (CCO) of the patient.

4. The method of claim 1, wherein the demographic data comprises of the age, race and sex of the patient.

5. The method of claim 1, wherein the physiological data comprises of:
Arterial Pressures (Systolic, Diastolic and Mean) (AR);
Heart Rate (HR);
Central Venous Pressure (CVP/RA);
Pulmonary Artery Pressure (PA/PAP);
Peripheral capillary oxygen saturation (SpO2);
Mixed venous oxygen saturation (SvO2);
Core body temperature (CBT); and
Continuous Systemic Vascular Resistance (CSVR).

6. The method of claim 1, further comprising preforming pre-processing of the captured clinical data of the patient, where the captured data is imputed with linear interpolation to obtain missing data streams in the captured data.

7. The method of claim 1, wherein the prediction model is adapted to learn patterns from the input data streams and identify patterns which shows similar patterns across different patients.

8. The method of claim 1, further comprising determining the accuracy of the prediction of the physiological parameter of the patient based on regression trees, which generates a collection of rules with regression models to generate predictions accurately.

9. The method of claim 8, wherein determining the accuracy of prediction of the physiological parameter comprises of:
splitting the captured clinical data into one or more training data sets and testing data sets;
creating a rule based model using the one or more training data sets;
estimating the predicted physiological parameter values from the one or more testing data sets; and
determining the accuracy of the predicted parameter values by comparing an output of the rule based model with the actual captured data.

10. The method of claim 9, wherein one of a squared error or correlation metric is implemented to validate the accuracy of predicted physiological parameter values.

11. A system for predicting a physiological condition of a patient, comprising:
a continuous data capturing unit configured for:
monitoring a plurality of patients during post-surgery recovery; and
developing a clinical database containing a clinical data captured from a plurality of historical patients having similar patient profiles; the clinical data comprising physiological data, vital signs, demographic details, pretreatment symptoms, treatments, and responses thereto, of the plurality of historical patients;
a data processing unit configured for:
identifying one or more recovery patterns for the similar patient profiles which exhibits likewise response to a selected treatment regime;
utilizing the one or more recovery patterns for learning the behavioral response of a physiological parameter of a patient; and
a Predictive Model Generator configured for:
creating a prediction model to enable automated classification of one or more similar patient profiles from existing recovery patterns of known symptoms and known responses to at least one treatment regime; and
predicting the physiological parameter of the patient ahead of time based on the captured physiological data of the patient.

12. The system of claim 11, wherein the physiological parameter comprises of a Continuous Cardiac Output (CCO) of the patient.

13. The system of claim 11, wherein the data processing unit is further adapted for processing the captured clinical data of the patient, where the captured data is imputed with linear interpolation to obtain missing data streams in the captured data.

14. The system of claim 11, wherein the data processing unit is further adapted for determining the accuracy of the predicted parameter values by comparing an output of the prediction model with the actual captured data.

15. The system of claim 11, further comprising a display unit adapted to display the predicted physiological parameter of the patient received from the data processing unit ahead of time.
